(19) United States
(12) Patent Application Publication
(10) Pub. No.: US 2004/0205506 A1
(43) Pub. Date: Oct. 14, 2004

(54) Webpage authoring tool that automatically modifies links in an HTML page sequence upon insertion of additional HTML pages

(75) Inventors: Tina M. Clark, Honeoye Falls, NY (US); Thomas J. Hoehn, Rochester, NY (US); Matthew H. Bernius, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/050,980

(22) Filed: Jan. 18, 2002

(51) Int. Cl. G06F 17/24

(52) U.S. Cl. 715/501.1; 715/500

(57) ABSTRACT

A website for displaying a plurality of HTML pages sequentially, the website includes a second HTML page; a first HTML page having a first-image link which links the first HTML page to the second HTML page so that the first HTML page is displayed sequentially first and the second HTML page sequentially second when the first link is activated; and a third HTML page, which is to be inserted in a predetermined position of either between the first and second HTML pages, before the first HTML page or after the second HTML page for forming a user-predetermined sequence order, containing a third-image link which either links the third image to both the first and second HTML page, to the second HTML page, or to the first HTML page; wherein the website automatically modifies either both the first link and second link, or adds an additional link in either the first or second HTML page so that the first, second and third HTML pages are displayed sequentially in the user-predetermined sequence order.

### CROSS-REFERENCE TO RELATED APPLICATIONS

The present application is related to U.S. application Ser. No. 09/966,314, filed Sep. 28, 2001, by Matthew H. Bernius and Thomas J. Hoehn, and entitled, “A Discussion Board of a Website Having Images”; U.S. application Ser. No. 09/944,551, filed Aug. 31, 2001, by Matthew H. Bernius and Thomas J. Hoehn, and entitled, “A Website Chat Room Having Images Displayed Simultaneously With Interactive Chatting”; and U.S. application Ser. No. 09/907,868, filed Jul. 18, 2001, by Matthew H. Bernius and Thomas J. Hoehn, and entitled, “A Website Having Images As A Navigational Tool For User-Created Photopages On The Internet; and U.S. Application docket number 83852, filed ______, by Thomas J. Hoehn and Matthew H. Bernius, and entitled “A Website on the Internet For Automated Interactive Display of Images.”

### FIELD OF THE INVENTION

The present intention relates to a collection of HTML pages displayed sequentially on the Internet and, more particularly, to inserting embedded links in each HTML page upon their creation which may cause automatic modification of the sequence in which the HTML pages are displayed based upon the display sequence data input by the user.

### BACKGROUND OF THE INVENTION

Currently known and utilized websites include HTML pages with embedded links, usually in the form of an icon, which link one HTML page to another. These links are used for sequentially navigating a collections of HTML pages as determined by the links therein.

Although the currently known and utilized internet based web page authoring tools that allow users to include links in their webpages are satisfactory, they include drawbacks. These tools do not include capability of altering the sequence of HTML pages by typical users after their creation. This is referred to in the art as “dumb” Web pages because the information being conveyed can become disjointed when adding additional HTML pages. Only those highly skilled in the art are capable of altering the sequence after their creation.

Consequently, a need exists for an internet based Web page authoring tool which automatically re-sequences HTML pages upon insertion of new HTML pages based upon the desire of user.

### SUMMARY OF THE INVENTION

The present invention is directed to overcoming one or more of the problems set forth above. Briefly summarized, according to one aspect of the present invention, the invention resides in a website for displaying a plurality of HTML pages sequentially, the website includes a second HTML page; a first HTML page having a first-image link which links the first HTML page to the second HTML page so that the first HTML page is displayed sequentially first and the second HTML page sequentially second when the first link is activated; and a third HTML page, which is to be inserted in a predetermined position of either between the first and second HTML pages, before the first HTML page or after the second HTML page for forming a user-predetermined sequence order, containing a third-image link which either links the third image to both the first and second HTML page, to the second HTML page, or to the first HTML page; wherein the website automatically modifies either both the first link and second link, or adds an additional link in either the first or second HTML page so that the first, second and third HTML pages are displayed sequentially in the user-predetermined sequence order.

These and other aspects, objects, features and advantages of the present invention will be more clearly understood and appreciated from a review of the following detailed description of the preferred embodiments and appended claims, and by reference to the accompanying drawings.

Advantageous Effect of the Invention

The present invention has the advantage of providing everyday Internet users a user-friendly mechanism for inserting HTML pages into an page sequence.

### BRIEF DESCRIPTION OF THE DRAWINGS

FIG. 1 is an illustration of the present invention showing the insertion of a new HTML page into a HTML page sequence on the Internet.

### DETAILED DESCRIPTION OF THE INVENTION

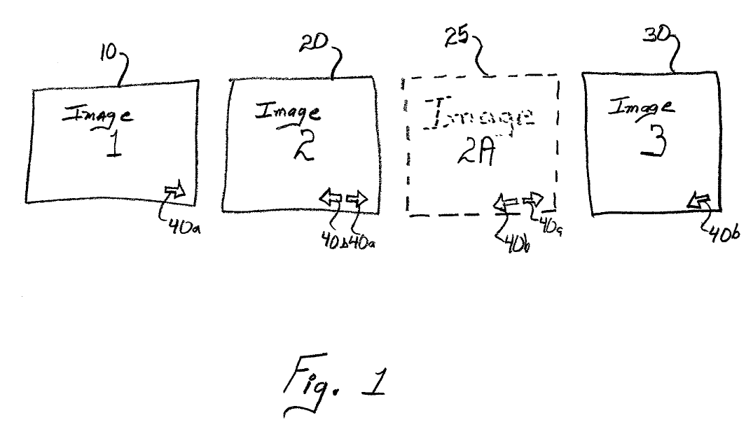

Referring to FIG. 1, there is shown an illustration of re-sequencing HTML pages of the present invention. In this regard, there is shown a plurality of HTML pages, for example three original HTML pages 10, 20 and 30 and a future HTML page 25 not yet created, each original HTML pages 10, 20 and 30 having an embedded link 40 therein which links one HTML page to another HTML page. According to their respective position in the sequence, the HTML pages may have either a forward link, a reverse line or both. For example, the first HTML page will only have a forward link 40a, the last HTML page will have a reverse link 40b and the middle HTML page will have both a forward link 40a and a reverse link 40b. These links 40 are embedded in each HTML page 10, 20 and 30 upon their creation and their particular sequence is determined by the user also upon creation. It facilitates understanding to note that, as originally created, HTML page 10 is linked forwardly to HTML page 20; HTML page 20 is linked reversibly to HTML page 10 and forwardly to HTML page 30; and HTML page 30 is linked reversibly to HTML page 20.

The user then creates the future HTML page 25 which is to be inserted between original HTML pages 20 and 30. When creating the future HTML page 25, the user inserts sequence data which automatically directs the internet based web page authoring tool to automatically create an embedded link 40a and 40b for linking this future HTML page 25 reversibly to image 10 and forwardly to image 30. The internet based web page authoring tool then modifies the original links in original HTML pages 20 and 30 so that original HTML page 20 is now linked forwardly to the future HTML page 25 and the HTML page 30 is linked reversibly to future HTML page 25. This re-linking maintains the continuity of the information being displayed so that it does not become disjointed upon the insertion of the future HTML page 25. It is instructive to note that this re-linking, Internet-based, web page authoring tool is available from Eastman Kodak Co. for licensing.

Although the invention has been described as inserting a new HTML page 25 in the middle portion of the sequence, it is readily recognized that the new HTML page 25 may be inserted as the first or last HTML page in the sequence. In the case of inserting the newly-inserted HTML page 25 as the initial page, the previous initial HTML page is 10 modified so that an additional link points reversely to the new initial HTML page 25. In the case of inserting the new HTML page 25 as the last page, a link in the previous last HTML page 30 is added so that it points forwardly to the new last HTML page 25.

The invention has been described with reference to a preferred embodiment. However, it will be appreciated that variations and modifications can be effected by a person of ordinary skill in the art without departing from the scope of the invention.

### Parts List

image 1

image 2

future image

image 3

links

1. A website for displaying a plurality of HTML pages sequentially, the website comprising:
(a) a second HTML page;
(b) a first HTML page having a first-image link which links the first HTML page to the second HTML page so that the first HTML page is displayed sequentially first and the second HTML page sequentially second when the first link is activated; and
(c) a third HTML page, which is to be inserted in a predetermined position of either between the first and second HTML pages, before the first HTML page or after the second HTML page for forming a user-predetermined sequence order, containing a third-image link which either links the third image to both the first and second HTML page, to the second HTML page, or to the first HTML page; wherein the website automatically modifies either both the first link and second link, or adds an additional link in either the first or second HTML page so that the first, second and third HTML pages are displayed sequentially in the user-predetermined sequence order.

2. The website as in claim 1, wherein the first and second links are graphical icons.

3. A method for displaying a plurality of HTML page sequentially in a website, the method comprising the steps of:
(a) receiving a second HTML page;
(b) receiving a first HTML page and creating a first-image link therein which links the first HTML page to the second HTML page so that the first HTML page is displayed sequentially first and the second HTML page sequentially second when the first link is activated; and
(c) a third HTML page, which is to be inserted in a predetermined position of either between the first and second HTML pages, before the first HTML page or after the second HTML page for forming a user-predetermined sequence order, containing a third-image link which either links the third image to both the first and second HTML page, to the second HTML page, or to the first HTML page; wherein the website automatically modifies either both the first link and second link, or adds an additional link in either the first or second HTML page so that the first, second and third HTML pages are displayed sequentially in the user-predetermined sequence order.

4. The method as in claim 3 further comprising providing graphical icons as the first and second links.
